(19) United States
(12) Patent Application Publication
(10) Pub. No.: US 2009/0269379 A1
(43) Pub. Date: Oct. 29, 2009

(54) Material Having Antibacterial and Antifungal Properties

(76) Inventor: Heinz Herbst, Lorrach (DE)

Correspondence Address: JoAnn Villamizar;Ciba Corporation/Patent Department, 540 White Plains Road, P.O. Box 2005, Tarrytown, NY, 10591, US

(21) Appl. No.: 12/083,054

(22) PCT Filed: Oct. 2, 2006
(86) PCT No.: PCT/EP2006/066947

§ 371 Date: Apr. 3, 2008

(30) Foreign Application Priority Data
Oct. 12, 2005 (EP) 05109468.8

(51) Int. Cl. A01N 25/34; A43B 17/00; A43B 13/00; A43B 13/38; A43B 23/07; A01P 3/00; A01P 1/00; A01N 43/54

(52) U.S. Cl. 424/404; 2/239; 36/25 R; 36/43; 36/55; 514/275

(57) ABSTRACT

A garment or footwear based on a synthetic thermoplastic polymer material containing (a) an antibacterial agent selected from phenolic antimicrobial compounds of the formula (I) wherein n is 0 or preferably 1, R₁ and R₂ are hydrogen or chloro, R₃ is hydroxyl or preferably hydrogen, R₄, R₅ and R₆ are hydrogen or chloro, R₇ is hydroxyl, and X is a direct bond, —NHCONH—, —CH₂— or preferably —O—; and (b) an antifungal agent selected from benzimidazole fungicides, triazoles, 2,4-bis(alkylamino)pyrimidines, isothiazolinon fungicides, 10,10′-oxy-bis-phenoxyarsen, zinc pyrithione has good antimicrobial properties.

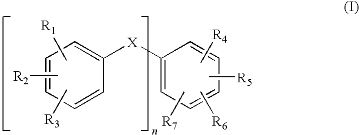

The invention pertains to a synthetic thermoplastic polymer material, especially a garment or shoe or material for the production of a garment or shoe, containing a specific combination of an antibacterial and an antifungal agent, to the use of these agents in or on a garment or shoe for the prevention of odor and tinea, and to a corresponding process for the production of an odor and tinea protective garment or shoe.

The use of certain biocides in garments directly worn on the skin, or shoes has been proposed (see U.S. Pat. No. 4,401,770; WO 03080911). WO 02023985 proposes a combination of phenolic and fungicidal agents for preserving leather. EP-A-1362885 teaches that discoloration of some thermoplastic compositions containing a silver-based antimicrobial agent may be prevented by addition of a certain base such as thiabendazole as a silver ion trapping agent.

Feet can smell as the foot sweats while it is trapped inside footwear. It is the interaction of these two factors along with bacteria that cause the smell. Feet have more sweat glands than any other part of the body, so they can sweat profusely which can not evaporate (like it can on the hands) due to being enclosed in footwear. The bacteria inter alia produce isovaleric acid which causes the odor.

Of special importance are, for example, the bacteriae Staphylococcus aureus, Micrococcus spp., Corynebacterium spp., Propionibacterium spp.; fungi of special importance include Trichophyton mentagophytes, Trichophyton rubrum, Epidermophyton floccosum.

Athlete's foot is a common condition in young people and adults. The fungi grow in warm, moist places with the result they are primarily a problem for people who wear tight-fitting trainers or don't dry their feet properly.

In order to reduce odor (malodorous; bromhidrosis) or fungal growth (e.g. athlete's foot, tinea pedis), especially in garments directly worn on the skin, or shoes such as sports or working shoes, further means are required, which effectively reduce odor and prevent fungal growth, while at the same time do not cause problems with respect to skin irritation, toxical effects, discolorations etc.

It now has been found that a combination of an antibacterial agent with a fungicide advantageously may be used to overcome the problems, thus providing a garment or footwear, especially a shoe, having antibacterial and thus anti-odor as well as anti-tinea properties.

The antibacterial agent (a) useful in the present invention mainly is

a phenolic antimicrobial compound of the formula (I)

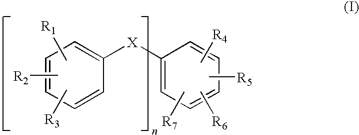

wherein
n is 0 or preferably 1,
R₁ and R₂ are hydrogen or chloro,
R₃ is hydroxyl or preferably hydrogen,
R₄, R₅ and R₆ are hydrogen or chloro,
R₇ is hydroxyl, and
   X is a direct bond, —NHCONH—, —CH₂— or preferably —O—.

Preferred examples for the antimicrobial component (a) include 2-phenylphenol, 2.4.4′-trichloro-2′-hydroxy-diphenylether, 4,4′-dichloro-2-hydroxy-diphenylether, 2,2′-methylene-bis-(4-chloro-phenol), 4-(2-t-butyl-5-methylphenoxy)-phenol, 3-(4-chlorophenyl)-1-(3,4-dichloro-phenyl)-urea, 2,4,6-trichlorophenol.

A silver ion releasing agent, e.g. a salt or silver complex salt such as AgCl, AgNO₃, Ag₂SO₄, silver-zeolites, silver-glass, silver-zirconates, may be used as additional antimicrobial component, e.g. in a weight ratio from about 1:9 to about 9:1 relative to present component a). The silver containing zeolites may be those described in U.S. Pat. Nos. 4,775,585, 4,911,898, 4,911,899 and 6,071,542, the disclosures of which are hereby incorporated by reference. A zeolite is generally aluminosilicate having a three dimensionally grown skeleton structure and is generally represented by xM_{2/n}O.Al₂O₃.ySiO₂.zH₂O, written with Al₂O₃ as a basis, wherein M represents an ion-exchangeable metal ion, which is usually the ion of a monovalent or divalent metal; n corresponds to the valence of the metal; x is a coefficient of the metal oxide; y is a coefficient of silica; and z is the number of water of crystallization. The zeolites to be used along with the antimicrobials of the present invention have a specific surface area of at least 150 m²/g.

More preferred as component a) are 2.4.4′-trichloro-2′-hydroxy-diphenylether, 4,4′-dichloro-2-hydroxydiphenylether, 2,2′-methylene-bis-(4-chloro-phenol), 3-(4-chlorophenyl)-1-(3,4-dichloro-phenyl)-urea.

The antifungal agent (b) useful in the present invention is selected from benzimidazole fungicides, triazoles, 2,4-bis(alkylamino)pyrimidines, isothiazolinon fungicides, 10,10′-oxy-bis-phenoxyarsen, zinc pyrithione.

Benzimidazole fungicides useful are, for example:

carbendazim (2-methoxycarbonylamino-benzimidazol [CAS: methyl 1H-benzimidazol-2-ylcarbamate; Reg. No. 10605-21-7]);
thiabendazole [CAS: 2-(4-thiazolyl)-1H-benzimidazole; Reg. No. 148-79-8];
triazoles useful are, for example:
tebuconazol ((RS)-1-p-chlorophenyl-4,4-dimethyl-3-(1H-1,2,4-triazol-1-ylmethyl)pentan-3-ol [CAS α-[2-(4-chlorophenyl)ethyl]-α-(1,1-dimethylethyl)-1H-1,2,4-triazole-1-ethanol, Reg. No. 107534-96-3]);

2,4-bis(alkylamino)pyrimidines useful are mainly those described in WO 05011758, i.e. compounds of the formula

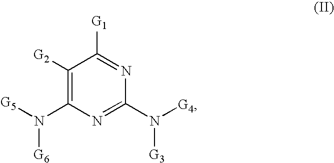

wherein
G₁ is C₁-C₁₂alkyl or C₆-C₁₀aryl;
G₂ is hydrogen or C₁-C₁₂alkyl; or G₁ and G₂ together form a radical of formula

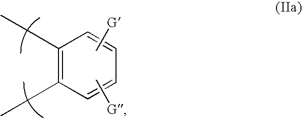

wherein
G′ and G″ are each independently of the other hydrogen, C₁-C₆alkyl or C₁-C₆alkoxy;
G₃ and G₅ are each independently of the other hydrogen or C₁-C₈alkyl;
G₄ is C₁-C₂₀alkyl, unsubstituted phenyl, C₆-C₁₀aryl, preferred C₇-C₁₀aryl; C₆-C₁₀aryl-C₁-C₆alkyl, hydroxy-C₁-C₆alkyl, di-C₁-C₆alkylamino-C₁-C₆alkyl, mono-C₁-C₆alkylamino-C₁-C₆alkyl, —(CH₂)₂—(O—(CH₂)₂)₁₋₄—OH or —(CH₂)₂—(O—(CH₂)₂)₁₋₄—NH₂;
G₆ is C₁-C₂₀alkyl, C₆-C₁₀aryl, C₆-C₁₀aryl-C₁-C₆alkyl, hydroxy-C₁-C₆alkyl, di-C₁-C₆alkylamino-C₁-C₆alkyl, mono-C₁-C₆alkylamino-C₁-C₆alkyl, —(CH₂)₂—(O—(CH₂)₂)₁₋₄—OH or —(CH₂)₂—(O—(CH₂)₂)₁₋₄—NH₂; or

G₃ and G₄ and/or G₅ and G₆ together form a pyrrolidine, piperidine, hexamethyleneimine or morpholine ring; typical examples of 2,4-bis(alkylamino)pyrimidines are of the formulae

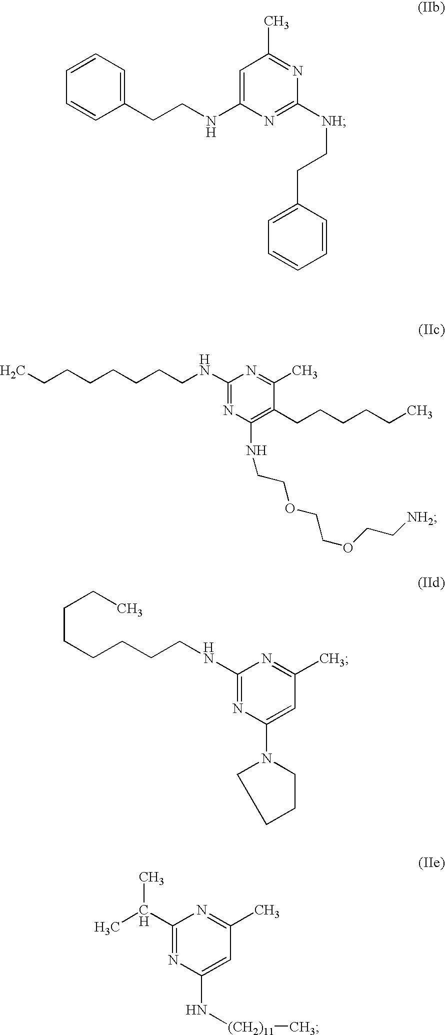

isothiazolinon fungicides useful are, for example:
2-n-octyl-4-isothiazolin-3-on, n-butyl-1,2-benzisothiazolin-3-on, 4,5-dichloro-N-n-octyl-isothiazolin-3-on;
zinc pyrithione [CAS Reg. No. 13463-41-7] is also known as 2-mercaptopyridine-1-oxide zinc salt.

Preferred fungicides are thiabendazol, tebuconazol, zinc pyrithione, 2-n-octyl-4-isothiazolin-3-on, 4,5-dichloro-N-n-octyl-isothiazolin-3-on, a 2,4-bis(alkylamino)pyrimidine of formula (IIb), (IIc), (IId);

especially thiabendazol, tebuconazol, zinc pyrithione.

Single compounds or mixtures of each component may be used. For example, using a combination of a phenolic antibacterial and a silver component may provide further advantages, e.g. as described in U.S. Pat. No. 6,585,989. Of course, one or more further components may be added selected from zinc oxide, copper and copper compounds, silver in general such as colloidal silver, silver nitrate, silver sulphate, silver chloride, silver complexes, metal-containing zeolites and surface-modified metal-containing zeolites, as described in said patent.

Components a) and b) are preferably used in a ratio ranging from 0.5:20 to 20:0.5, especially a):b) in a ratio from 1:10 to 10:1.

The total amount of components a) and b) preferably is in the range from 0.01% to 10%, especially 0.02% to 5%, by weight of the treated garment or shoe or corresponding material.

The antimicrobial mixture of components a) and b) exhibit good long-term activity and a good toxicological profile.

The novel antimicrobial mixture of components a) and b) may be incorporated into a plastic resin prior to its being manufacturing process such as rotational molding, fiber spinning, etc. The mixture of components a) and b) is able to withstand demanding processing conditions such as high temperature, e.g. temperatures greater than 200° C.

Consequently, the invention also pertains to a process for the preparation of an antimicrobial material, especially a garment or footwear, characterized in that an antibacterial agent and an antifungal agent as defined above under (a) and (b) are incorporated therein, as well as to the use of a combination of an antibacterial agent (a) and an antifungal agent (b) for the production of a garment or footwear.

Examples for the materials such as plastic resins polymer substrates equipped with antimicrobial activity according to the present invention are:

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).
   2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
   3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is gene-rated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
   4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).
6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.
8. Halogen-containing polymers such as polychloroprene, chlorinated rubbers, chlorinated and brominated copolymer of isobutylene-isoprene (halobutyl rubber), chlorinated or sulfo-chlorinated polyethylene, copolymers of ethylene and chlorinated ethylene, epichlorohydrin homo- and copolymers, especially polymers of halogen-containing vinyl compounds, for example polyvinyl chloride (PVC), polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.
9. Polymers derived from α,β-unsaturated acids and derivatives thereof such as polyacrylates and polymethacrylates; polymethyl methacrylates, polyacrylamides and polyacrylonitriles, impact-modified with butyl acrylate.
10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.
11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.
12. Homopolymers and copolymers of cyclic ethers such as polyalkylene glycols, polyethylene oxide, polypropylene oxide or copolymers thereof with bisglycidyl ethers.
13. Polyacetals such as polyoxymethylene and those polyoxymethylenes which contain ethylene oxide as a comonomer; polyacetals modified with thermoplastic polyurethanes, acrylates or MBS.
14. Polyphenylene oxides and sulfides, and mixtures of polyphenylene oxides with styrene polymers or polyamides.
15. Polyurethanes derived from hydroxyl-terminated polyethers, polyesters or polybutadienes on the one hand and aliphatic or aromatic polyisocyanates on the other, as well as precursors thereof.
16. Polyamides and copolyamides derived from diamines and dicarboxylic acids and/or from aminocarboxylic acids or the corresponding lactams (PA), for example polyamide 4, poly-amide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).
17. Polyureas, polyimides, polyamide-imides, polyetherimids, polyesterimids, polyhydantoins and polybenzimidazoles.
18. Polyesters derived from dicarboxylic acids and diols and/or from hydroxycarboxylic acids or the corresponding lactones, for example polyethylene terephthalate (PET), polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.
19. Natural polymer materials such as leather, cellulose, rubber, gelatin and chemically modified homologous derivatives thereof, for example cellulose acetates, cellulose propionates and cellulose butyrates, or the cellulose ethers such as methyl cellulose; as well as rosins and their derivatives.
20. Blends of the aforementioned polymers (polyblends), for example PP/EPDM, Poly-amide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.
21. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.
22. Aqueous emulsions of natural or synthetic rubber, e.g. natural latex or lattices of carboxylated styrene/butadiene copolymers.
23. Polysiloxanes such as the soft, hydrophilic polysiloxanes described, for example, in U.S. Pat. No. 4,259,467; and the hard polyorganosiloxanes described, for example, in U.S. Pat. No. 4,355,147.

Preferred substrates are polyethylene such as LDPE or HDPE, polypropylene (PP; homo or copolymer), ethylene vinylacetate (EVA), PET, PET-G, polyol, thermoplastic polyolefin (TPO), polyurethane, thermoplastic polyurethane (TPU), PVC, PA such as PA 6 or PA 6.6. Substrates may be foams.

The materials, garments or shoes of the present invention, especially the polymer substrates, may also have incorporated therein one or more of the following known additives:

### 1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.
1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.
1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octade-cyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.
1.4. Tocopherols, for example α-tocopherol, β-tocopherol, γ-tocopherol, δ-tocopherol and mixtures thereof (vitamin E).
1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide.
1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra(5-tert-butyl-4-hydroxy-2-methylphenyl)pentane.
1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.
1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.
1.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.
1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicyclohexyl-4-hydroxybenzyl)isocyanurate.
1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.
1.12. Acylaminophenols, for example 4-hydroxylauranilide, 4-hydroxystearanilide, octyl N-(3,5-di-tert-butyl-4-hydroxyphenyl)carbamate.
1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.14. Esters of β-(5-tert-butyl-4-hydroxy-3-methylphenyl)propionic acid with mono- or poly-hydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.
1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard® XL-1, supplied by Uniroyal).
1.18. Ascorbic acid (vitamin C)
1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-iso-propoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazine, N,N,N′,N′-tetraphenyl-1,4-diaminobut-2-ene.

### 2. UV Absorbers and Light Stabilizers

2.1. 2-(2′-Hydroxyphenyl)benzotriazoles, for example 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethyl butyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,αdimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonyl-ethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole; 2-[2′-hydroxy-3′-(1,1,3,3-tetramethylbutyl)-5′-[(α,α-dimethylbenzyl)phenyl]benzotriazole.
2.2. 2-Hydroxybenzophenones, for example the 4-hydroxy, 4-methoxy, 4-octyloxy, 4-decyl-oxy, 4-dodecyloxy, 4-benzyloxy, 4,2′,4′-trihydroxy and 2′-hydroxy-4,4′-dimethoxy derivatives.
2.3. Esters of substituted and unsubstituted benzoic acids, for example 4-tert-butylphenyl salicylate, phenyl salicylate, octylphenyl salicylate, dibenzoyl resorcinol, bis(4-tert-butyl-benzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.
2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate and N-(β-carbomethoxy-β-cyanovinyl)-2-methylindoline.
2.5. Nickel compounds, for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.
2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethyl piperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethyl-piperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexyl-amino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-di-aza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine.

The sterically hindered amine may also be one of the compounds described in GB-A-2 301 106 as component I-a), I-b), I-c), I-d), I-e), I-f), I-g), I-h), I-i), I-j), I-k) or I-l), in particular the light stabilizer 1-a-1, 1-a-2, 1-b-1, 1-c-1, 1-c-2, 1-d-1, 1-d-2, 1-d-3, 1-e-1, 1-f-1, 1-g-1, 1-g-2 or 1-k-1 listed on pages 68 to 73 of said GB-A-2 301 106.

The sterically hindered amine may also be one of the compounds described in EP-A-0 782 994, for example compounds as described in claim 10 or 38 or in Examples 1-12 or D-1 to D-5 therein.

2.7. Sterically hindered amines substituted on the N-atom by a hydroxy-substituted alkoxy group, for example compounds such as 1-(2-hydroxy-2-methylpropoxy)-4-octadecanoyloxy-2,2,6,6-tetramethyl piperidine, 1-(2-hydroxy-2-methylpropoxy)-4-hexadecanoyloxy-2,2,6,6-tetramethylpiperidine, the reaction product of 1-oxyl-4-hydroxy-2,2,6,6-tetramethylpiperidine with a carbon radical from t-amylalcohol, 1-(2-hydroxy-2-methylpropoxy)-4-hydroxy-2,2,6,6-tetramethylpiperidine, 1-(2-hydroxy-2-methylpropoxy)-4-oxo-2,2,6,6-tetramethylpiperidine, bis(1-(2-hydroxy-2-methylpropoxy)-2,2,6,6-tetramethylpiperidin-4-yl) sebacate, bis(1-(2-hydroxy-2-methylpropoxy)-2,2,6,6-tetramethylpiperidin-4-yl) adipate, bis(1-(2-hydroxy-2-methylpropoxy)-2,2,6,6-tetramethylpiperidin-4-yl) succinate, bis(1-(2-hydroxy-2-methylpropoxy)-2,2,6,6-tetramethylpiperidin-4-yl) glutarate and 2,4-bis{N-[1-(2-hydroxy-2-methylpropoxy)-2,2,6,6-tetramethylpiperidin-4-yl]-N-butylamino}-6-(2-hydroxyethylamino)-s-triazine.
2.8. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.
2.9. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyl-oxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.
3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.
4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-di benz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-[2-methyl-dibenz[d,g]-1,3,2-dioxaphosphocin, 2,2′,2″-nitrilo-[triethyltris(3,3′,5,5′-tetra-tert-butyl-1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

The following phosphites are especially preferred:

Tris(2,4-di-tert-butylphenyl) phosphite (Irgafos® 168, Ciba Specialty Chemicals Inc.), tris(nonylphenyl) phosphite,

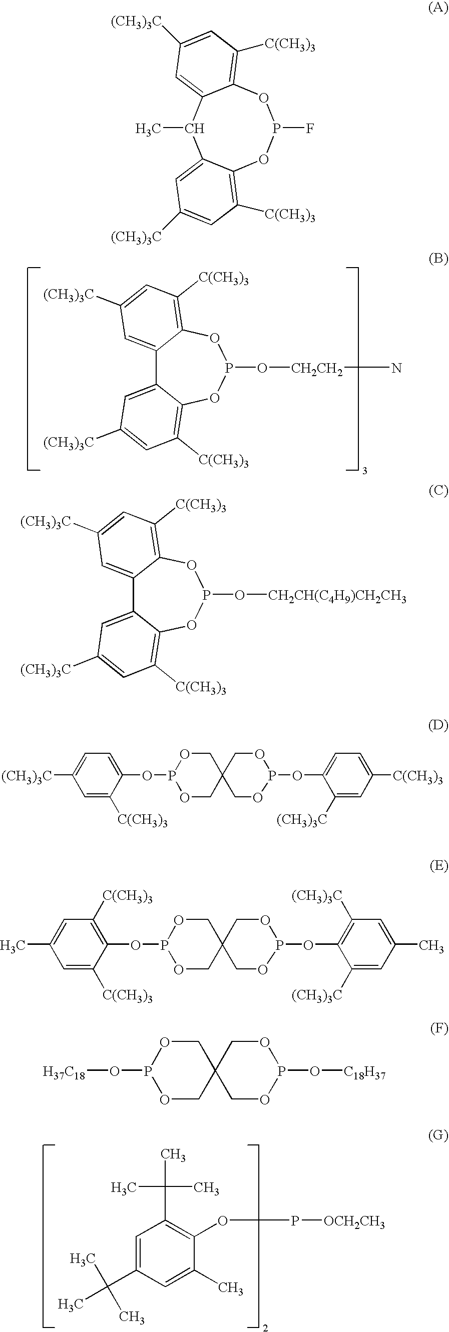

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-di-hexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.
6. Nitrones, for example N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.
7. Amine oxides, for example amine oxide derivatives as disclosed in U.S. Pat. Nos. 5,844,029 and 5,880,191, didecyl methyl amine oxide, tridecyl amine oxide, tridodecyl amine oxide and trihexadecyl amine oxide.
8. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839 or EP-A-0591102 or 3-[4-(2-acetoxyethoxy)phenyl]-5,7-di-tert-butylbenzofuran-2-one, 5,7-di-tert-butyl-3-[4-(2-stearoyloxyethoxy)phenyl]-benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one.
9. Thiosynergists, for example dilauryl thiodipropionate or distearyl thiodipropionate.
10. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.
11. Polyamide stabilizers, for example copper salts in combination with iodides and/or phosphorus compounds and salts of divalent manganese.
12. Basic co-stabilisers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.
13. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyl-dibenzylidene)sorbitol, and 1,3:2,4-di(benzylidene)sorbitol.
14. Fillers and reinforcing agents, for example calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.
15. Other additives, for example plasticisers, lubricants, emulsifiers, pigments, dyes, rheology additives, catalysts, flow-control agents, optical brighteners, slip agents, crosslinking agents, crosslinking boosters, halogen scavengers, smoke inhibitors, flameproofing agents, antistatic agents, clarifiers such as substituted and unsubstituted bisbenzylidene sorbitols, benzoxazinone UV absorbers such as 2,2′-p-phenylene-bis(3,1-benzoxazin-4-one), Cyasorb® 3638 (CAS#18600-59-4), and blowing agents.
16. Other biocides, for example fungicides such as 3,5-dimethyl-tetrahydro-1,3,5-2H-thio-diazin-2-thione, Bis-tributyltinoxide, 4.5-dichlor-2-n-octyl-4-isothiazolin-3-one, N-butyl-benzisothiazoline, 10.10′-oxybisphenoxyarsine, zinc-2-pyridinthiol-1-oxide, etc., and algicides such as 2-methylthio-4-cyclopropylamino-6-(α,β-di-methylpropylamino)-s-triazine, 2-methylthio-4-cyclopropylamino-6-tert-butylamino-s-triazine, 2-methylthio-4-ethylamino-6-(α,α-di-methylpropylamino)-s-triazine, etc.

These additives are often contained in amounts ranging from 0.01 to 10% by weight of the material; usual amounts for these additional additives are ranging from about 0.05 to 5% by weight. Fillers may be contained in higher amounts, e.g. 1-50% b.w.

Preferred additional additives are selected from the group consisting of antioxidants, ultra-violet light absorbers, hindered amines, phosphites or phosphonites, hydroxylamines, nitrones, benzofuran-2-ones, thiosynergists, polyamide stabilizers, metal stearates, nucleating agents, fillers, reinforcing agents, lubricants, emulsifiers, dyes, pigments, optical brighteners, flame retardants, antistatic agents and blowing agents.

Components a) and b), i.e. the additives of the invention, and optional further additives may be added to the plastic resin, e.g. the polyolefin, individually or mixed with one another. If desired, the individual components of an additive mixture can be mixed with one another in the melt (melt blending) before incorporation into the plastic material.

The incorporation of the mixture of components a) and b) and optional further additives into the plastic material may be carried out by known methods such as dry mixing in the form of a powder, or wet mixing in the form of solutions or suspensions. Components a) and b) and optional further additives may be incorporated, for example, before or after molding or also by applying the dissolved or dispersed stabilizer mixture to the plastic material, with or without subsequent evaporation of the solvent.

Components a) and b) and optional further additives can also be added to the plastic material in the form of a masterbatch (“concentrate”) which contains these components in a concentration of about 1 to 80%, for example 2.5% to 70%, especially 5% to 50% or 1% to about 40% by weight of the loaded carrier; in such operations, the polymer can be used in the form of powder, granules, solutions, suspensions or in the form of lattices. The polymer must not be necessarily of identical structure than the polymer where the additives are added finally. The invention thus embraces a process for the production of an antimicrobial garment or footwear, wherein the antibacterial agent (a) and antifungal agent (b) are first incorporated into a thermoplastic polymer carrier in an amount ranging from 1 to 80% by weight of the carrier, and the loaded carrier is subsequently incorporated into the material, where both steps are carried out with application of heat.

If added to a plastic resin in the form of a masterbatch or concentrate, the novel antimicrobial mixture of components a) and b) preferably is added via carriers such as LDPE, HDPE, MDPE, PP, EVA, ABS, SAN, PS, acrylates, PMMA, polyamide, polyesters, PVC, latex, styrene, polyol, TPU, unsaturated esters, urea, paraformaldehyde, water emulsion, etc.; especially preferred are LDPE, HDPE, PP, EVA, PA 6, PA 6.6, PET, PET-G (i.e. glycol-modified PET), PVC, TPU.

Components a) and b) and optional further additives can also be added before, during or after polymerization or crosslinking.

Components a) and b) and optional further additives can be incorporated into the plastic material in pure form or encapsulated in waxes, oils or polymers.

Components a) and b) and optional further additives can also be sprayed onto the material. They are able to dilute other additives (for example the conventional additives indicated above) or monomers or their melts so that they can be sprayed also together with these additives onto the material. Addition by spraying during the deactivation of the polymerization catalysts is particularly advantageous, it being possible to carry out spraying using, for example, the steam used for deactivation.

In general, the additives of the invention and optional further components may be added to the polymer material individually or mixed with one another. If desired, the individual components can be mixed with one another before incorporation into the polymer for example by dry blending, compaction or in the melt.

The incorporation of the additives of the invention and optional further components into the polymer is carried out by known methods such as dry blending in the form of a powder, or wet mixing in the form of solutions, dispersions or suspensions for example in an inert solvent, water or oil. The additives of the invention and optional further additives may be incorporated, for example, before or after molding or also by applying the dissolved or dispersed additive or additive mixture to the polymer material, with or without subsequent evaporation of the solvent or the suspension/dispersion agent. They may be added directly into the processing apparatus (e.g. extruders, internal mixers, etc), e.g. as a dry mixture or powder or as solution or dispersion or suspension or melt.

The incorporation can be carried out in any heatable container equipped with a stirrer, e.g. in a closed apparatus such as a kneader, mixer or stirred vessel. The incorporation is preferably carried out in an extruder or in a kneader. It is immaterial whether processing takes place in an inert atmosphere or in the presence of oxygen.

The addition of the additive or additive blend to the polymer can be carried out in all customary mixing machines in which the polymer is melted and mixed with the additives. Suitable machines are known to those skilled in the art. They are predominantly mixers, kneaders and extruders.

Incorporation is preferably carried out in an extruder by introducing the additive during processing.

Particularly preferred processing machines are single-screw extruders, contrarotating and corotating twin-screw extruders, planetary-gear extruders, ring extruders or cokneaders. It is also possible to use processing machines provided with at least one gas removal compartment to which a vacuum can be applied.

Suitable extruders and kneaders are described, for example, in Handbuch der Kunststoffex-trusion, Vol. 1 Grundlagen, Editors F. Hensen, W. Knappe, H. Potente, 1989, pp. 3-7, ISBN: 3-446-14339-4 (Vol. 2 Extrusionsanlagen 1986, ISBN 3-446-14329-7).

For example, the screw length is 1-60 screw diameters, preferably 35-48 screw diameters. The rotational speed of the screw is preferably 10-600 rotations per minute (rpm), very particularly preferably 25-300 rpm.

The maximum throughput is dependent on the screw diameter, the rotational speed and the driving force. The process of the present invention can also be carried out at a level lower than maximum throughput by varying the parameters mentioned or employing weighing machines delivering dosage amounts.

If a plurality of components are added, these can be premixed or added individually.

The additives of the invention and optional further additives can also be sprayed onto the polymer material. They are able to dilute other additives (for example the conventional additives indicated above) or their melts so that they can be sprayed also together with these additives onto the material. Addition by spraying during the deactivation of the polymerization catalysts is particularly advantageous; in this case, the steam evolved may be used for deactivation of the catalyst. In the case of spherically polymerized polyolefins it may, for example, be advantageous to apply the additives of the invention, optionally together with other additives, by spraying.

Incorporation can take place prior to or during the shaping operation, or by applying the dissolved or dispersed compound to the polymer, with or without subsequent evaporation of the solvent. In the case of elastomers, these can also be stabilized as lattices. A further possibility for incorporating the additives of the invention into polymers is to add them before, during or directly after the polymerization of the corresponding monomers or prior to crosslinking. In this context the additive of the invention can be added as it is or else in encapsulated form (for example in waxes, oils or polymers).

The materials containing the additives of the invention described herein can be used for the production of moldings, rotomolded articles, injection molded articles, blow molded articles, films, tapes, mono-filaments, fibers, foams, nonwovens, profiles, adhesives or putties, surface coatings and the like.

Present components a) and b) are mainly used in footwear materials such as socks, preferably in shoes, especially in thermoplastic or duroplastic materials thereof e.g. like the sole, insole, lining, or of the whole shoe, e.g. boots (rubber, PVC), clog, etc. Typical materials are PVC, EVA, TPU, PUR, PET, PA such as PA 6 or PA 6.6, rubber.

The materials may be foamed, especially in case of insoles.

The following examples illustrate the invention in more detail. They are not to be construed as limiting the instant invention in any manner whatsoever. The invention is declared to cover all changes and modifications of the specific examples which do not constitute departure from the spirit and scope of the invention.

### EXAMPLE 1

10% of 2,4,4′-trichloro-2′-hydroxydiphenylether and 10% of thiabendazol are incorporated into a polyester of the type PET-G (Eastar© 6763, Eastman):

A mixture of the polymer and containing 10% b.w. of 2,4,4′-trichloro-2′-hydroxydiphenylether and 10% b.w. of thiabendazol is homogenized using a mechanical agitator and then compounded to granules in a single screw extruder (Göpfert) at 230° C. maximum temperature under nitrogen.

### EVA Test Disks

The PET-G masterbatch described above (1 or 3%) is incorporated into ethylenevinylacetate (Escorene© OILED 00119, Exxon) by homogenization of the masterbatch granules and the polymer in a mechanical agitator (Röhnrad Mischer). For comparison purposes, a further sample is prepared containing no masterbatch.

Compounding to granules is effected in a twin extruder at 200° C. maximum temperature under nitrogen. Granules are dried at 65° C. Test disks of 2 mm thickness are die casted.

### Antimicrobial Activity

The antimicrobial activity of the test disks is evaluated using the method AATCC 100. For this, a defined quantity (0.15 ml) of a culture of microorganisms is applied to the surface of a test disk of dimension 40×40 mm. The inoculum is covered with a sterile film in order to avoid desiccation. Samples are incubated at 37° C. and >90% relative humidity (RH). After 24 hours, the number of microorganisms survived is determined. A culture of Staphylococcus aureus ATCC 6538 is used. Results are compiled in the below table.

| Sample | | | | Log reduction vs. |
|---|---|---|---|---|
| No. | Composition | 0′ | 24 hours | sample 1 |
| 1 | Reference | 1.8 × 10⁶ | 1.3 × 10⁶ | |
| | (no masterbatch) | | | |
| 2 | 1% masterbatch | 1.8 × 10⁶ | 1.1 × 10⁴ | 2.1 |
| 3 | 3% masterbatch | 1.8 × 10⁶ | 1.8 × 10³ | 2.9 |

Samples 2 and 3 of the invention show a distinct reduction of Staphylococcus aureus.

### Antifungal Activity

According to ISO 846, method B, antifungal activity is investigated using Trichophyton metagophytes, Trichophyton rubrum or Epidermophyton floccosum.

Disks of 30×30 mm, put on the agar as specified, are inoculed by spraying with the culture of fungal spores in the specified medium. Disks are incubated at 24° C. for a period of 4 weeks (exposition period) with weekly visual assessment. Results showing the size of the inhibition zone on the sample disks and/or the percentage of growth are given in the below tables.

Trichophyton metagophytes NCPF 89

| | | Exposition | | | |
|---|---|---|---|---|---|
| | | Period/Inhibition Zone [mm] | | | |
| No. | Composition | 7 days | 14 days | 21 days | 28 days |
| 1 | reference (no masterbatch) | 0 | 0 | 0 | 0 |
| 2 | 1% masterbatch | 25 | 25 | 25 | 25 |
| 3 | 3% masterbatch | 25 | 25 | 25 | 25 |

| | | Exposition Period/Growth [%] | | | |
|---|---|---|---|---|---|
| No. | Composition | 7 days | 14 days | 21 days | 28 days |
| 1 | reference (no masterbatch) | 0 | 0 | 0 | 0 |
| 2 | 1% masterbatch | 0 | 0 | 0 | 0 |
| 3 | 3% masterbatch | 0 | 0 | 0 | 0 |

Trichophyton rubrum NCPF 115

| | | Exposition | | | |
|---|---|---|---|---|---|
| | | Period/Inhibition Zone [mm] | | | |
| No. | Composition | 7 days | 14 days | 21 days | 28 days |
| 1 | reference (no masterbatch) | 0 | 0 | 0 | 0 |
| 2 | 1% masterbatch | 25 | 25 | 25 | 25 |
| 3 | 3% masterbatch | 25 | 25 | 25 | 25 |

| | | Exposition Period/Growth [%] | | | |
|---|---|---|---|---|---|
| No. | Composition | 7 days | 14 days | 21 days | 28 days |
| 1 | reference (no masterbatch) | 50 | 50 | 50 | 50 |
| 2 | 1% masterbatch | 0 | 0 | 0 | 0 |
| 3 | 3% masterbatch | 0 | 0 | 0 | 0 |

Epidermophyton floccosum NCPF 634

| | | Exposition | | | |
|---|---|---|---|---|---|
| | | Period/Inhibition Zone [mm] | | | |
| No. | Composition | 7 days | 14 days | 21 days | 28 days |
| 1 | reference (no masterbatch) | 0 | 0 | 0 | 0 |
| 2 | 1% masterbatch | 16 | 12.5 | 10 | 5 |
| 3 | 3% masterbatch | 20 | 8 | 5 | 0 |

| | | Exposition Period/Growth [%] | | | |
|---|---|---|---|---|---|
| No. | Composition | 7 days | 14 days | 21 days | 28 days |
| 1 | reference (no masterbatch) | 0 | 20 | 100 | 100 |
| 2 | 1% masterbatch | 0 | 0 | 0 | 0 |
| 3 | 3% masterbatch | 0 | 0 | 0 | 0 |

Samples 2 and 3 of the invention show a distinct grow inhibition.

### EXAMPLE 2

### Plasticized PVC Sheets

0.5% of the 2,4-bis(alkylamino)pyrimidine compounds of formula (IIc) or (IId) are dissolved in diisododecyl phthalate (DIDP) plasticizer.

The total mixture (6000 g) consists of

| | |
|---|---|
| 63.5 p.b.w. of | PVC (Evipol ® SH 7020) |
| 35.5 p.b.w. of | DIDP (Vestnol ® DZ) |
| 1.5 p.b.w. of | Irgaplast ® 39* |
| 1.3 p.b.w. of | IRGASTAB ® BZ 561* |
| 0.25 p.b.w. of | 2-(2′-hydroxy-3′,5′-di-tert.butylphenyl)-benzotriazole |
| | UV absorber (CAS Reg.-Nr.003846-71-7)* |

(*additives available at Ciba Specialty Chamicals Inc.).

The solid components are filled into the mixer (Papenmeier) and stirred at 700 rpm and heated. As soon as the mixture temperature reaches 60° C. the liquid components are injected. The speed of the mixer is increased to 1800 rpm and the temperature increased to 100° C. When the 100° C. level is reached, speed is reduced to 700 rpm and the mixture is cooled down to 50-60° C. The mixture is plasticized on a two roll mill (Schwabenthan D-1) for a period of 8 minutes at 150-160° C. Sheets of 400 micron thickness obtained are used for the preparation of the test disks.

### Antifungal Activity

The antifungal activity of test disks is evaluated using the method AATCC 100. For this, a defined quantity (0.1 ml) of a culture of microorganisms is applied to the surface of a test disk of dimension 2 cm diameter resulting in a final concentration of fungi on the sample of ˜10⁵ colony forming units (CFU). Samples are incubated at 29° C. and >90% relative humidity (RH). After 1 week incubation time, the number of microorganisms survived is determined. A culture of Trichophyton mentagophytes ATCC 9553 or Trichophyton rubrum ATCC 10218 is used. Results are compiled in the below table

Results: CFU/sample

| | Samples | 0 hours | 1 week | Log reduction |
|---|---|---|---|---|
| | | Trichophyton metagophytes ATCC 9553 | | |
| 1 | reference, PVC | 8.8 × 10⁵ | 1.5 × 10⁶ | |
| | | | 1.9 × 10⁶ | |
| 2 | PVC + 0.5% (IIc) | ″ | 3.0 × 10⁴ | 1.8 |
| | | | 3.0 × 10⁴ | |
| | | Trichophyton rubrum ATCC 10218 | | |
| 3 | reference, PVC | 2.4 × 10⁴ | 1.1 × 10⁵ | |
| | | | 4.9 × 10⁵ | |
| 4 | PVC + 0.5% (IId) | ″ | 600 | 2.7 |
| | | | 600 | |
| 5 | PVC + 0.5% (IIc) | ″ | <200 | 3.2 |
| | | | <200 | |

The samples of the invention show a distinct reduction of Trichophyton mentagophytes and Trichophyton rubrum.

1. Antibacterial and antifungal synthetic thermoplastic polymer material which is part of a garment or footwear, or synthetic thermoplastic polymer material for the production of a garment or footwear, containing
(a) an antibacterial agent selected from phenolic antimicrobial compounds of the formula (I) 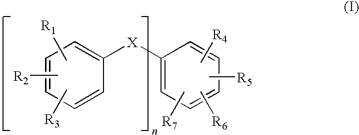
wherein
n is 0 or 1,
R₁ and R₂ are hydrogen or chloro,
R₃ is hydroxyl or hydrogen,
R₄, R₅ and R₆ are hydrogen or chloro,
R₇ is hydroxyl, and
X is a direct bond, —NHCONH—, —CH₂— or —O—; and
(b) an antifungal agent selected from benzimidazole fungicides, triazoles, 2,4-bis(alkylamino)pyrimidines, isothiazolinon fungicides, 10,10′-oxy-bis-phenoxyarsen and zinc pyrithione
incorporated into the bulk of the material.

2. Material of claim 1, wherein component (b) is selected from the group consisting of thiabendazol, tebuconazol, zinc pyrithione, 2-n-octyl-4-isothiazolin-3-on, 4,5-dichloro-N-n-octyl-isothiazolin-3-on and 2,4-bis(alkylamino)pyrimidines of the formulae (IIb), (IIc) or (IId)

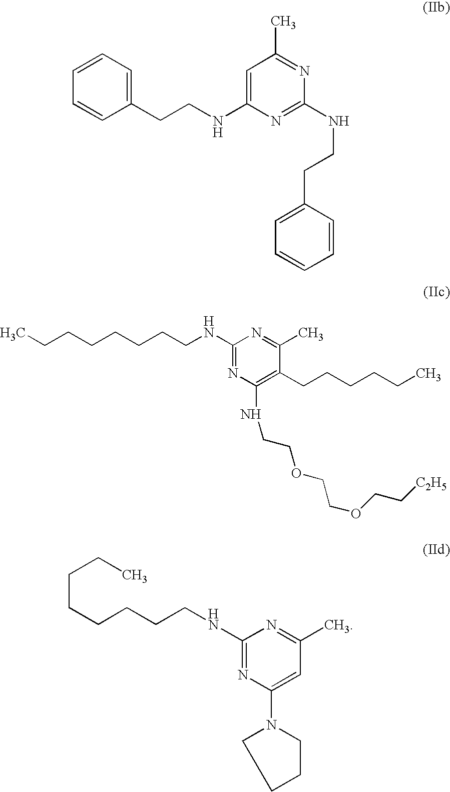

3. Material of claim 1, wherein component (a) is selected from 2-phenylphenol, 2,4,4′-trichloro-2′-hydroxy-diphenylether, 4,4′-dichloro-2-hydroxydiphenylether, 2,2′-methylene-bis-(4-chloro-phenol), 4-(2-t-butyl-5-methylphenoxy)-phenol, 3-(4-chlorophenyl)-1-(3,4-dichloro-phenyl)-urea and 2,4,6-trichlorophenol.

4. Material of claim 1, wherein the garment or footwear is a sock or a shoe or a shoe sole, insole or lining.

5. Material of claim 1, containing a ratio of components a):b) ranging from 0.5:20 to 20:0.5, and a total amount of components a) and b) in the range from 0.01% to 10% by weight of the garment or footwear or corresponding material.

6. Material of claim 1, further containing a silver ion releasing agent selected from a silver salt and a silver complex salt.

7. Process for the preparation of a material according to claim 1, characterized in that an antibacterial agent (a) and an antifungal agent (b) as defined in claim 1 are incorporated into the bulk of the material.

8. Process according to claim 7, wherein components (a) and (b) are incorporated into the bulk of the material, which is a synthetic thermoplastic polymer selected from polyethylene, polypropylene homo or copolymers, ethylene vinylacetate, polyester, polyol, polyurethane, thermoplastic polyurethane, polyvinylchloride and polyamide.

9. Process according to claim 8, wherein one or more compounds selected from the group consisting of antioxidants, phosphites, phosphonites, benzofuranones, indolinones, further antimicrobial agents and light stabilizers are also incorporated into the synthetic thermoplastic polymer.

10. Process according to claim 7, wherein the antibacterial agent (a) and antifungal agent (b) are first incorporated into a thermoplastic polymer carrier in an amount ranging from 1 to 80% by weight of the carrier, and the loaded carrier is subsequently incorporated into the material and where both steps are carried out with application of heat.

11. (canceled)
